(19) United States
(12) Patent Application Publication
(10) Pub. No.: US 2013/0256058 A1
(43) Pub. Date: Oct. 3, 2013

(54) VARIABLE VOLUME AERIAL WORK PLATFORM

(71) Applicant: Giovanni Borghi, Modena (IT)

(72) Inventor: Giovanni Borghi, Modena (IT)

(73) Assignee: C.M.C. S.R.L. - SOCIETA UNIPERSONALE, Modena (IT)

(21) Appl. No.: 13/819,661

(22) PCT Filed: Aug. 31, 2011
(86) PCT No.: PCT/IB11/02004

§ 371 Date: Mar. 21, 2013

(30) Foreign Application Priority Data
Sep. 2, 2010 (IT) MO2010A000248

(51) Int. Cl. B66F 11/04

(52) U.S. Cl. CPC B66F 11/04
USPC 182/113

(57) ABSTRACT

An aerial work platform associated with a self-moving operating machine that includes: a fixed central body, rectangular in plan view, provided with two guard sides, located at its sides, and a central platform situated at the bottom; at least one extension module, hinged to said central body at one side, consisting of a three side structure that defines an articulated parallelogram on a horizontal plane, for assuming two configurations, a flattened rest configuration, in which said three sides are folded against said fixed central body, and an open working one, in which the same three sides are at an angle one to another to define a side body, aligned with said fixed central body. A side platform, positioned in the side body, is aligned with said central platform. Locking means for stabilizing said open work configuration of said extension module, are provided between the side platform and said sides.

The invention relates to the technical field concerning self-propelled operating machines, for example of the type used in building industry, agriculture or the like.

Some of these machines are provided with a lifting mechanism, for example of the type having an arm, to whose free end an aerial work platform designed to carry persons is associated.

When the machine is positioned, the platform is lifted, so as to allow workers present thereon to carry out the works in maximum safety conditions.

For some kinds of works, for example building ones, platforms are used which allow the contemporary presence of more workers, obviously ensuring a sufficient operation space.

The just mentioned aerial platforms usually are rectangular in plan view and have extendable portions, so as to have, in work configuration, a sufficiently wide (about 4 m) front along their bigger sides.

Once closed, the same portions reduce the size of the bigger sides to about 2.2 m, to allow the operating machine to run on the road remaining within the allowed profile limits.

A work platform of known type is provided with extendable portions according to a substantially bellows pattern, which is quite complicated and expensive, because of high number of components and joints.

Moreover, the hard use conditions of the aerial work platforms, severe weather conditions and, often, inadequate maintenance, make the joints hard to operate and consequently, the opening and closing operations of the extendable portions become difficult.

Therefore, it is an object of the present invention to propose a variable volume aerial work platform, shaped in such a way as to be simpler than those of known type, so as to limit the production costs and, at the same time, ensure best functionality with respect thereto of the opening and closing operations.

Another object of the invention is to propose an aerial work platform which, having dimensions similar to those known in closed configuration, is longer when in work configuration.

A further object of the invention is to propose a robust and stable aerial work platform to ensure the maximum safety for the workers present therein.

The characteristics of the invention will become evident from the following description of the preferred embodiments of the aerial work platform under discussion, in accordance with the contents of the claims and with help of the enclosed figures, in which:

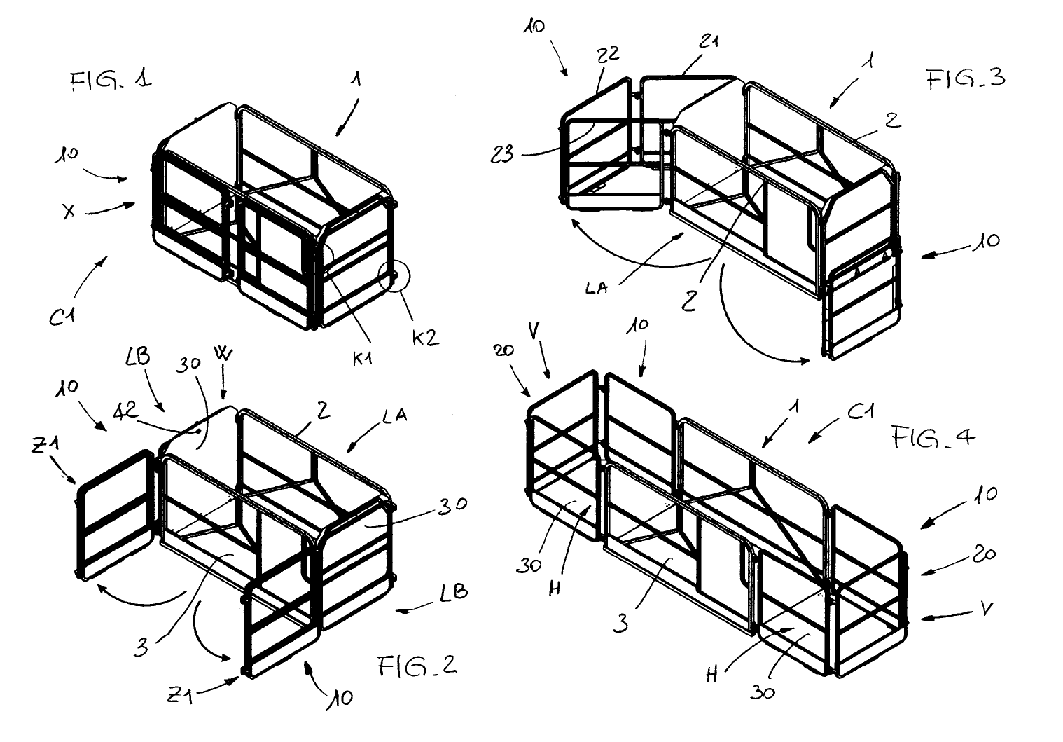

FIGS. 1 to 4 illustrate a first embodiment of the aerial work platform in corresponding opening steps of the relative extension modules;

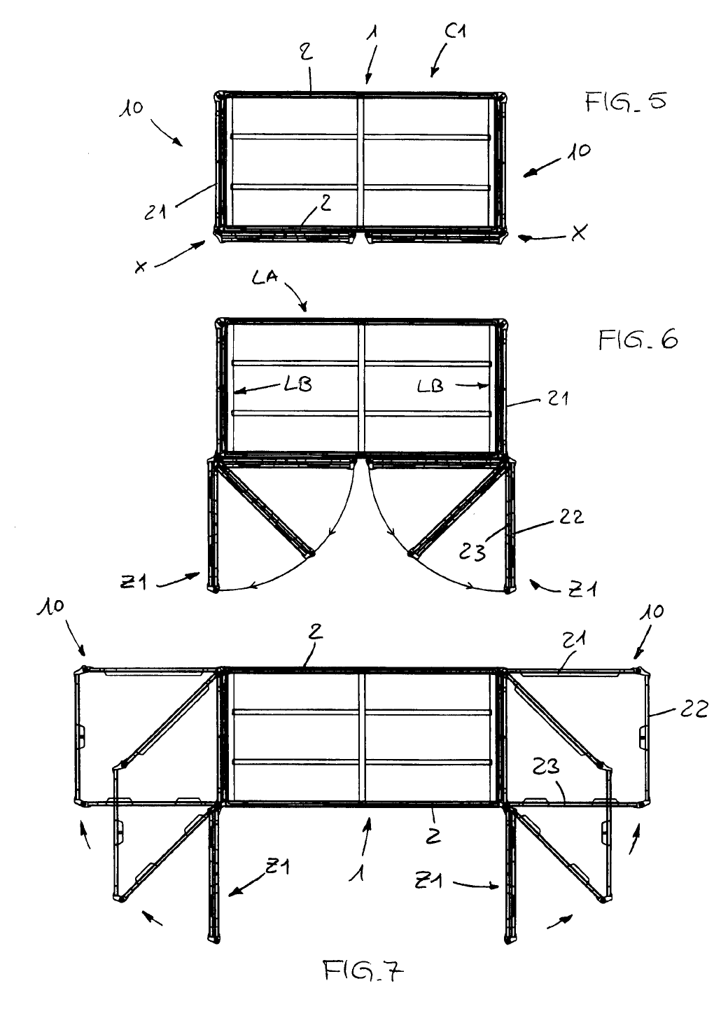

FIGS. 5, 6, 7 are plan views of the aerial work platform of the previous Figures, in the same opening steps;

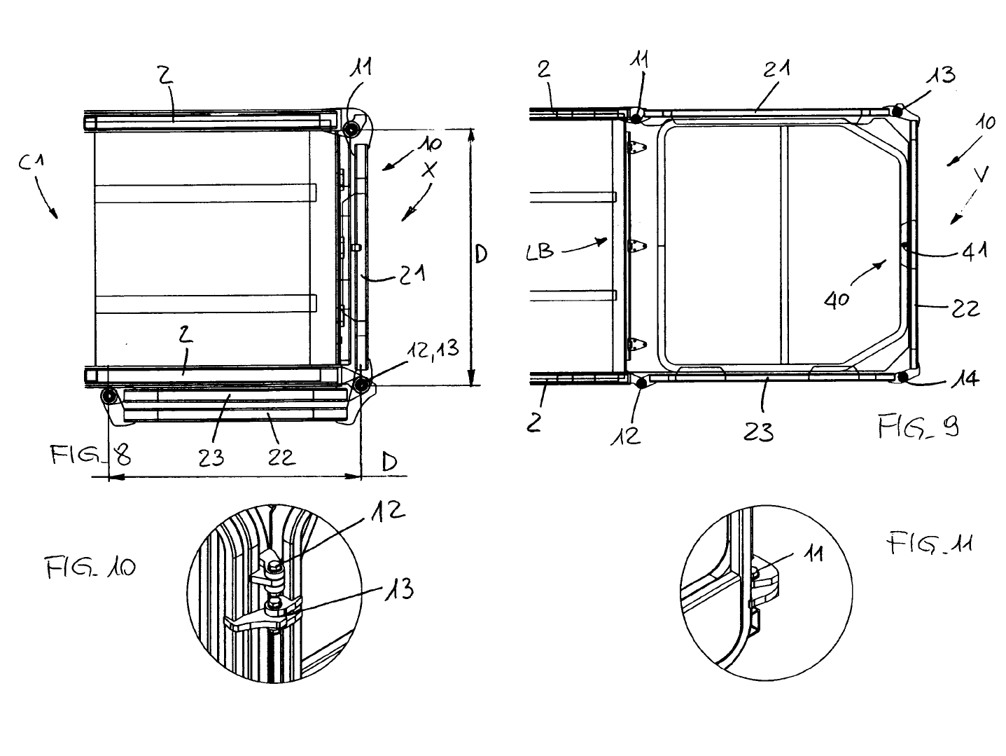

FIG. 8 is a partially plan view in enlarged scale similar to FIG. 5;

FIG. 9 is a partially plan view in enlarged scale similar to FIG. 7;

FIG. 10 illustrates the detail K1 of FIG. 1 in enlarged scale;

FIG. 11 illustrates the detail K2 of FIG. 1 in enlarged scale;

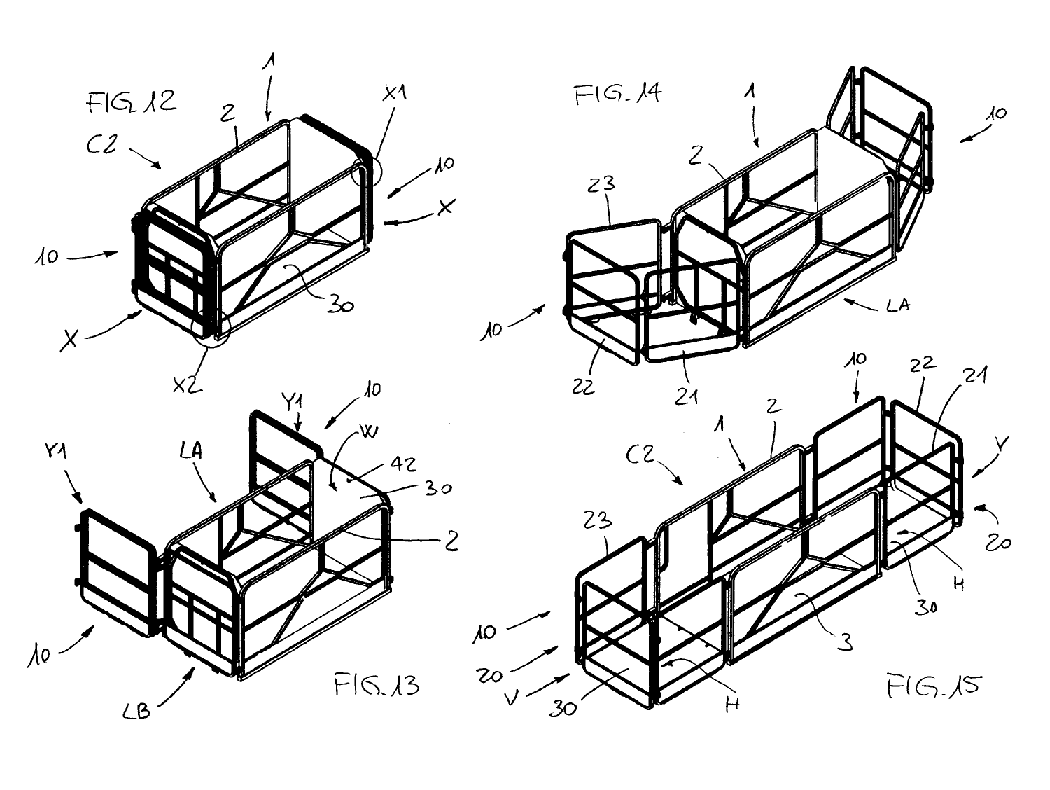

FIGS. 12 to 15 illustrate a second embodiment of the aerial work platform in corresponding opening steps of the relative extension modules;

FIGS. 16, 17, 18 are plan views of the aerial work platform of the previous Figures, in the same opening steps;

FIG. 19 is a partially plan view in enlarged scale similar to FIG. 16;

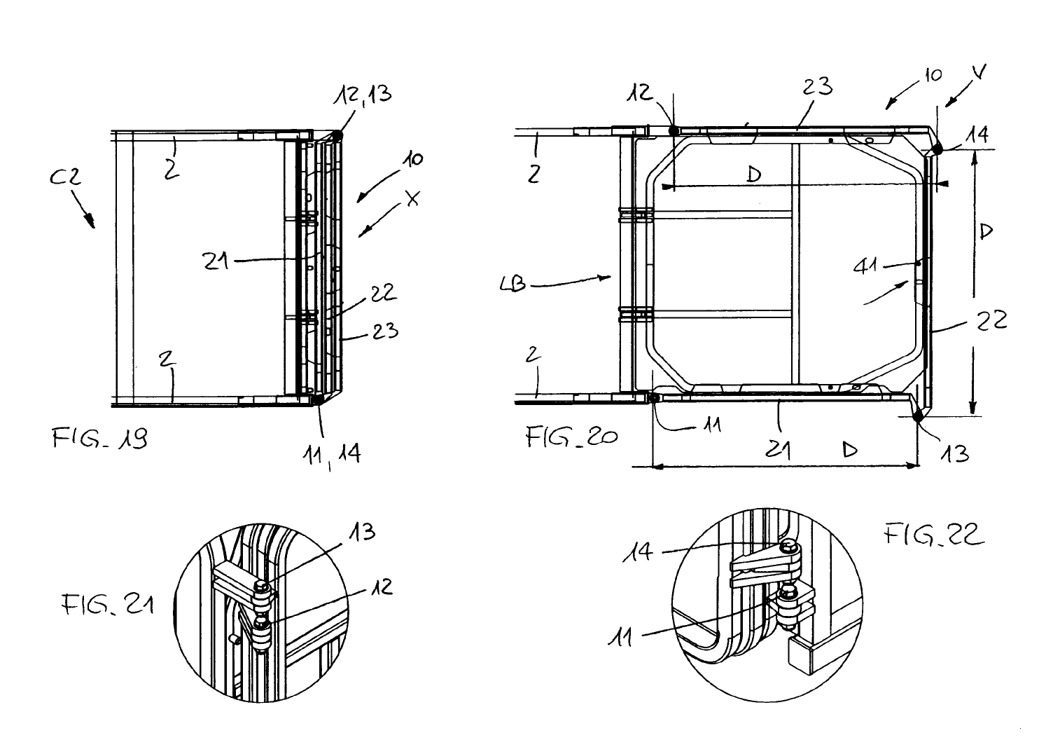

FIG. 20 is a partially plan view in enlarged scale similar to FIG. 18;

FIG. 21 illustrates the detail X1 of FIG. 12 in enlarged scale;

FIG. 22 illustrates the detail X2 of FIG. 12 in enlarged scale.

In the above mentioned FIGS. 1 to 11, the reference C1 indicates a first embodiment of the variable volume aerial work platform under discussion, whereas in FIGS. 12 to 22, the reference C2 indicates a second embodiment thereof.

The work platform C1, C2 is aimed, as a not limiting example, at being associated to the lifting mechanism of a self-moving operating machine, not shown, and is aimed at housing one or more workers who must be lifted to work at height.

The aerial work platform C1, C2 in both embodiments includes:
a fixed central body 1, rectangular in plan view, in which there are two guard sides 2, located at the long sides LA of said rectangle, and a central platform 3, situated at the bottom;
at least one extension module 10, associated to said central body 1 at one of the smaller sides LB of said rectangle, and hinged to the guard sides 2 through first and second vertical hinges 11, 12.

In the examples referred to in the Figures, there are two extension modules 10 associated to the two opposite smaller sides LB.

Each extension module 10 consists of a three side structure, with a first 21, second 22 and third side 23 being mutually hinged through third and fourth vertical hinges 13, 14.

In particular, it is provided that:
said first side 21 has its ends hinged respectively to one of said guard sides 2, through said first hinges 11, and to a corresponding end of said second side 22 through said third hinges 13;
the other end of said second side 22 is hinged to a corresponding end of said third side 23, through said fourth hinges 24;
the other end of said third side 23 is hinged to the other guard side 2, through said second hinges 12.

In practice, an articulated parallelogram configuration, mobile on a horizontal plane, is formed between the three sides 21, 22, 23 of each extension module 10 and the corresponding smaller side LB of the fixed central body 1.

Each of said hinges 11, 12, 13, 14 is spaced from the adjacent ones by a constant distance D, to allow the respective extension module 10 to take two configurations, respectively a flattened, non-work configuration X, in which said three sides 21, 22, 23 are folded and placed against said fixed central body 1, and an open working one V, in which said three sides 21, 22, 23 are arranged at an angle to one another, as it is better specified later, to define a side body 20, set beside and aligned with said fixed central body 1.

Said second and third hinges 12, 13 are arranged at different heights and are designed to be coaxial in the flattened, non-work configuration X of the respective extension module 10, for the reasons better explained later on (FIGS. 10, 11, 21, 22).

A side platform 30 is provided for each extension module 10, hinged to the fixed central body 1 and aimed at being rotated from a vertical non-work position W, assumed when said extension module 10 is in the flat rest configuration X, to a horizontal work position H, allowed after the passage of the same module 10 to the open work configuration V.

In such horizontal work position H, the lateral platform 30 is beside and aligned with said central platform 3.

Locking means 40, designed to stabilize said open work configuration V are provided in the extension module 10.

Said locking means 40 include, for example, at least one pin 41, associated with said second side 22 of the structure, aimed at engaging with a corresponding hole 42 provided in said platform 3.

In the mentioned first embodiment of the aerial work platform C1, the flattened rest configuration X of each extension module 10 (FIGS. 1, 5, 8) is performed in three steps:
a) rotation of the three sides 21, 22, 23 of the structure with respect to the hinges 11, 12, 13, 14, to bring said first side 21 to be leaning against and parallel to the corresponding said shorter side LB of the rectangle, with the resulting book-like closing of the second and third sides 22, 23, which are set close to each other (position Z1 in FIGS. 2, 6, 7);
b) rotation of said second and third side 22, 23 together about the axis of said second and third hinges 12, 13, arranged coaxial, to be, in turn, set close and parallel to a corresponding guard side 2 of the fixed central body 1.

Obviously, the inverse operations change the flattened rest configuration X to the open work configuration V (FIGS. 4, 9).

Similarly, also in the mentioned second embodiment of the aerial work platform C2, the flattened rest configuration X of each extension module 10 (FIGS. 12, 16, 19) is performed in two steps:
a) rotation of the three sides 21, 22, 23 of the structure with respect to the hinges 11, 12, 13, 14, to bring said first side 21 to be leaning against and parallel to the corresponding said shorter side LB of the rectangle, with the resulting book-like closing of the second and third sides 22, 23, which are set close to each other (position Y1 in FIGS. 13, 17, 18);
b) rotation of said second and third side 22, 23, set close to each other, together about the axis of said second and third hinges 12, 13, arranged coaxial, to be, in turn, set close and parallel to the first side 21.

In order to allow the described rotation of said second and third side 22, 23 together, said first and fourth hinges 11, 14 are arranged at different heights, so as to be coaxial when the three sides 21, 22, 23 are set close to each other.

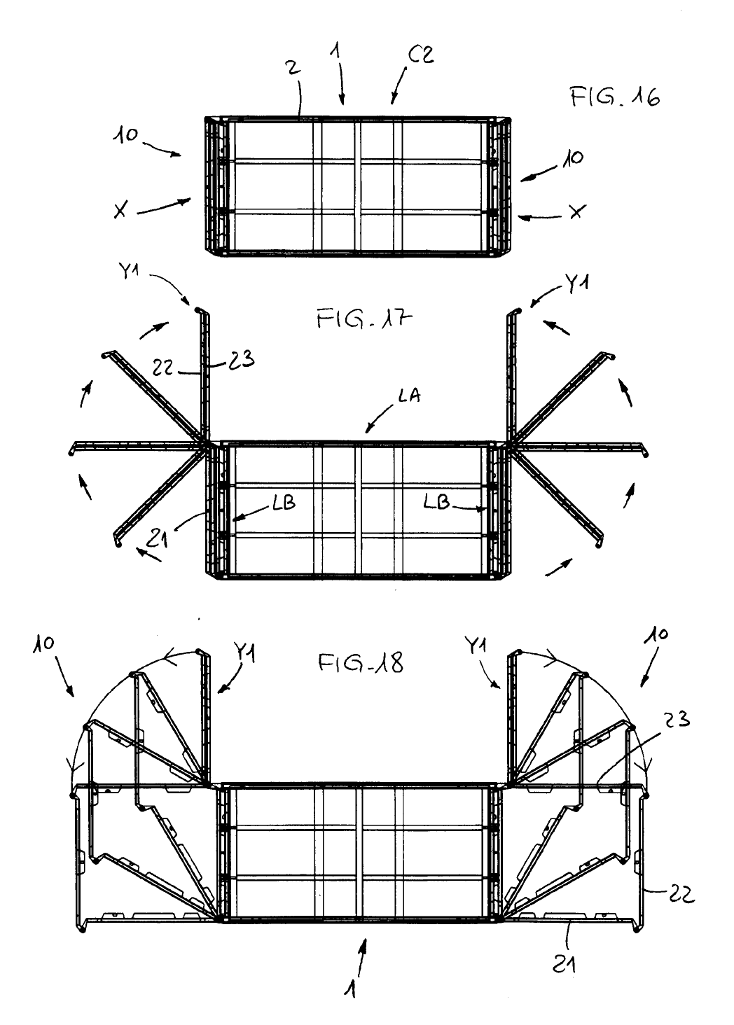

Also in this case, the inverse operations change the flattened rest configuration X to the open work configuration V (FIGS. 15, 20).

In the mentioned embodiments, both the aerial work platform C1 and the aerial work platform C2 are provided with further locking means, not shown as they are known, aimed at stabilizing the respective flattened rest configuration X of each extension module 10.

The aerial work platform under discussion, in both described embodiments, reaches fully the objects indicated in the introductory note, due to the articulated parallelogram conformation, which is defined between the three sides of each extension module and the corresponding smaller side of the fixed central body.

The fact that all the hinges have the same distance and the calculated arrangement thereof, with the coaxial conditions mentioned before, allow to obtain easily the closed and open configurations with less elements with respect to the prior art solutions.

This aspect turns out to be advantageous for limiting the production costs and, at the same time, ensures a better functionality of the extension modules.

As it is obvious from the above description, the proposed aerial work platform is extremely compact in closed configuration, whereas the obtained length increase is the maximum possible, that is equal to the dimension of the smaller side of the central body, for each module.

The module structure helps to ensure the strength and stability of the aerial work platform, for the maximum safety of the workers present thereon.

In any case, it is understood that what above has only illustrative and not limiting value, therefore possible detail modifications applied for technical and/or functional reasons, are considered from now on within the protective scope defined by the claims reported below.

1. Variable volume aerial work platform including:
a fixed central body rectangular in plan view, in which there are two guard sides, located at the long sides of said rectangle, and a central platform, situated at the bottom;
at least one extension module, associated to said central body at one of the smaller sides of said rectangle, and articulated to these guard sides through first and second vertical hinges, with said at least one extension module consisting of a three side structure, with a first, second, and third side, which sides form with a smaller sides of said central body a articulated parallelogram mobile on a horizontal plane, said three sides being mutually articulated through third and fourth vertical hinges, with each of said hinges spaced from the adjacent ones by a constant distance, to allow said at least one extension module to take two configurations, namely a flattened, non-work one in which said three sides are folded and placed against said fixed central body, and an open, work one, in which said three sides are arranged at an angle to one another, to define a side body set beside and aligned to said fixed central body;
a side platform, provided to be placed in said side body, when arranged in said open, work configuration, set beside and aligned with said central platform;
locking means, designed to stabilize said open, work configuration of said at least one extension module;
said first side of the structure having its ends respectively articulated to one of said guard sides, through said first hinges, and to a corresponding end of said second side through said third hinge;
the remainder end of said second side of the structure being hinged to a corresponding end of said third side, through said fourth hinges;
the remainder end of said third side of the structure being hinged to a corresponding end of said third side, through said fourth hinges,
wherein said second and third hinges are arranged at different heights and are designed to be coaxial in the flattened, non-work configuration of said at least one extension module; in said flattened, non-work configuration said first side of the structure is leaning against and parallel to the corresponding said shorter side of the rectangle and said second and third sides are set close to each other and are adapted to be rotated jointly about the axis of said second and third hinges, arranged coaxial, to be set close and parallel to a corresponding said guard side of the fixed central body.

2. Aerial work platform according to claim 1, wherein said second and third sides of the structure, set close to each other in said flattened, non-work configuration of said at least one extension module, are adapted to be rotated jointly about the axis of said second and third hinges arranged coaxial, to be set close and parallel to said first side.

3. Aerial work platform according to claim 2 wherein said first and fourth hinges are arranged at different heights and are designed to be coaxial in the flattened, non-work configuration, in which said three sides, are set close to each other.

4. Aerial work platform according to claim 1 wherein in said open, work configuration of said at least one extension module, said first and third sides are parallel to and nearly aligned with the corresponding said guard sides, said second side being set orthogonal to said first and third sides.

5. Aerial work platform according to claim 1, wherein said side platform is hinge-bound to said fixed central body and is capable of being rotated between a vertical inoperative position and a horizontal operative one in which it is set beside and aligned with said central platform.

6. Aerial work platform according to claim 1, wherein said locking means include at least one pin, associated with said second side of the structure, such as to engage with a corresponding hole provided in said platform.
